(19) United States
(12) Patent Application Publication
(10) Pub. No.: US 2012/0206715 A1
(43) Pub. Date: Aug. 16, 2012

(54) METHANE MONITORING SYSTEM

(76) Inventor: Charles Laub, Riverside, MO (US)

(21) Appl. No.: 13/371,509

(22) Filed: Feb. 13, 2012

Related U.S. Application Data
(60) Provisional application No. 61/441,672, filed on Feb. 11, 2011.

(51) Int. Cl. G01N 21/35; G01N 27/00

(52) U.S. Cl. 356/51; 73/31.05

(57) ABSTRACT

A methane monitoring system including a filter, a flow restrictor and a methane level detector is disclosed. The sensor system draws gas from a piping system through a sample line into the filter. The filter removes moisture vapor from the gas, with the remaining gas passing into a flow meter. The flow meter regulates the gas pressure for the gas output to a sensing chamber containing the methane meter. The methane meter operates to sample the methane level in the gas and provides an electrical signal which can be output to a recording device such as a flash memory card or to real time remote reporting via direct connection or a wireless signal such as a cell phone, radio or satellite telecom system. Landfill gas which is introduced into the sensing chamber is then exhausted through vent slots in the housing.

### CROSS REFERENCE TO RELATED APPLICATIONS

The present application claims the benefit of U.S. Provisional Patent Application Ser. No. 61/441,672 filed Feb. 11, 2011 entitled “METHANE MONITORING SYSTEM” which is hereby incorporated by reference in its entirety to the extent not inconsistent.

### FIELD OF THE INVENTION

The present invention generally relates to a system for monitoring methane content within landfill gas. More particularly, the present invention pertains to a system for monitoring methane content within gas collected by a landfill gas system, where the system includes replaceable parts, such as a desiccant filter, sealed methane meter, or the like.

### BACKGROUND OF THE INVENTION

In the past, trash was often collected and placed in local and regional landfills. Most of these small landfills have been replaced by large landfill facilities. Today, about 55 percent of America's trash (more than 220 million tons annually) is disposed of in landfills. The Environmental Protection Agency (EPA) reports that, in 2007, there were over 3,000 active landfills operating in the United States.

Modern landfills are well-engineered facilities that are located, designed, operated, and monitored to provide compliance with federal regulations. Solid waste landfills must be designed to protect the environment from contaminants which may be present in the solid waste stream. A typical modern landfill is lined with a layer of clay and protective plastic to prevent the waste and leachate (liquid from the wastes) from leaking into the ground or groundwater. A network of drains at the bottom of the landfill collects the leachate that flows from the decomposing waste for treatment.

In addition to leachate, landfill gas is generated when refuse in landfills decomposes. In many cases, the gas is composed of approximately 55% methane with the remaining constituents consisting primarily of carbon dioxide along with trace amounts of other organic gases. To collect these gases landfill gas collection systems are constructed with the drilling of wells, followed by the installation of pipelines, and the construction of gas compressor stations, flaring stations, and scrubbing and treatment stations. Collection systems for landfill gas are designed to prevent the migration of methane and other gases into the atmosphere and into adjacent structures or properties where they represent risks of explosion, fire, and/or health hazards. Landfill gas recovered from landfills is typically either flared or developed as an alternative energy source.

Gas monitoring systems include fixed installations capable of periodic and continuous monitoring as well as portable and handheld devices for spot checking surface gas levels. These systems are used for complying with the Greenhouse Gas Reporting Rule (40 CFR Part 98) which requires periodic reports of methane concentrations. The fixed installations normally utilized in conjunction with landfill piping systems to comply with these regulations can be both expensive to purchase or lease as well as to maintain. Furthermore, handheld devices are very labor intensive means of collecting the data necessary to comply with the regulations listed above.

The invention described herein solves the problem of collecting, analyzing, and reporting landfill gas level information for ultimately improving overall landfill monitoring efficiency as it pertains to equipment and maintenance as well as convenience.

### SUMMARY OF THE INVENTION

Disclosed is a self-contained methane monitoring system, such as for use in a landfill, having sealed components. In one embodiment, the methane monitoring system is housed in a weatherproof container which have sealed access panels suitable for facilitating the replacement of key components. The housing may also include a mounting portion for facilitating the placement of the system on the collector pipe of a landfill methane system.

Another form of the present invention provides a methane monitoring system housed in an access panel, which includes a water trap/particular filter, desiccant filter and a sealed methane detector.

Yet other forms, embodiments, objects, advantages, benefits, features, and aspects of the present invention will become apparent from the detailed description and drawings contained herein.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a side plan view of a methane monitoring system according to one embodiment of the present invention.

FIG. 2 is a front plan view of the methane monitoring system of FIG. 1.

FIG. 3 is an in-line view of the methane monitoring system of FIG. 1 showing one method for securement to the collector pipe of a landfill system.

FIG. 4 is a front plan view of a methane monitoring system according to another embodiment of the present invention.

### DESCRIPTION OF THE SPECIFIC EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Disclosed is a landfill gas monitoring system which includes an environmentally protective housing containing a desiccant filter, a flow restrictor/meter and a methane level detector. The system is intended for use in high moisture content areas, such as landfills, to monitor the methane level within landfill gas. The system draws gas from a landfill piping system through a sample line into the water trap/particulate filter and/or desiccant filter. The water trap/particulate filter and/or desiccant filters protects the methane meter from moisture which can potentially affect the accuracy of the concentrations observed. The roto meter regulates the gas flow from the sample line to a substantially constant flow for output to an isolated sensing chamber containing the methane meter sensing elements. The methane meter operates to sample the methane level in the output gas and provides an electrical signal which can be transmitted to a recording device such as a flash memory card or to a real-time remote reporting device via direct connection or wireless signal. Landfill gas which is introduced into the sensing chamber is then exhausted through vent slots in the system's otherwise sealed housing.

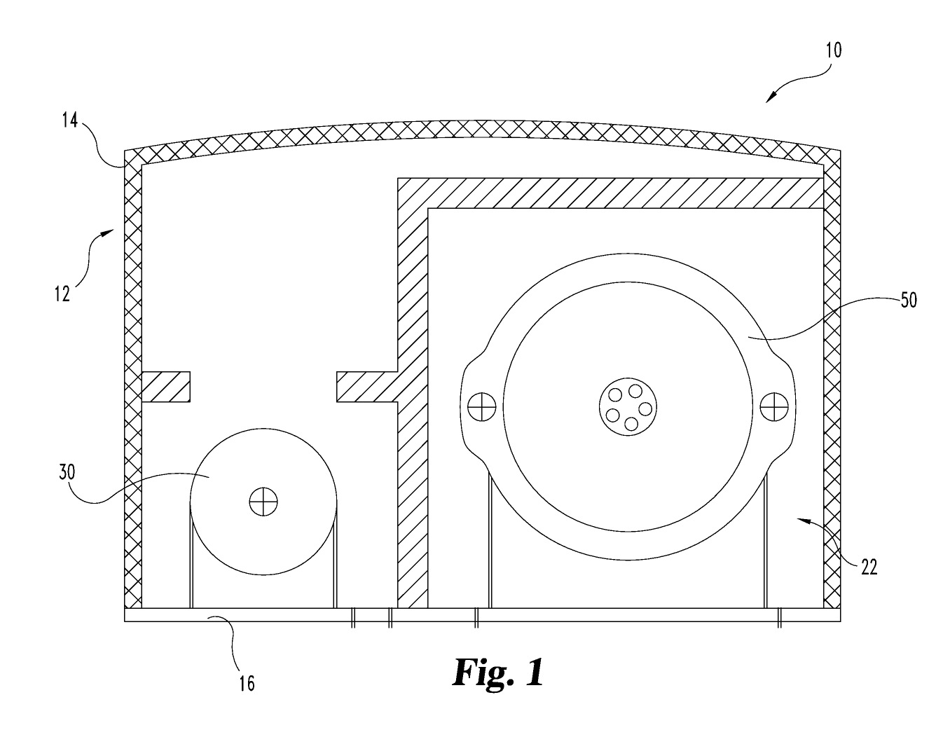

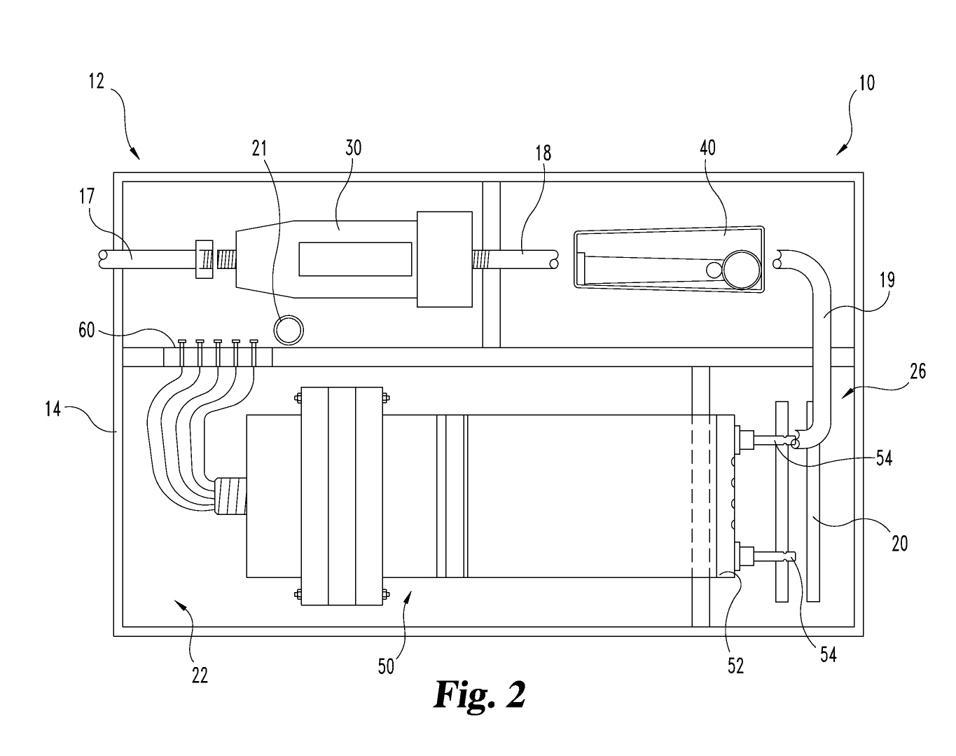

Turning to FIGS. 1-2, side and front plan views of a methane monitoring system 10 according to one embodiment of the present invention are shown. System 10 includes a main housing 12 which is typically a rigid housing. Housing 12 may be constructed of polycarbonate, stainless steel, or some other suitable material. Preferably, housing 12 includes a removable lid 14 to allow access to internal components of system 10 which are, in the illustrated embodiment, mounted to base plate 16. In certain alternative forms, main housing 12 may provide selective access to the internal components of system 10 through one or more re-sealable access panels integrated therein. It shall be appreciated that the use of the term “connected” shall include both directly connected and/or connected in fluid communication by a conduit, such as a pipe, hose, fitting or the like.

System 10 includes a gas inlet pipe 17 for connection to a landfill piping system to receive gas for subsequent sampling and vents 20 for dissipation of the sampled gas. System 10 further includes a desiccant filter 30, flow meter 40, methane meter 50, and contact terminal 60. Desiccant filter 30 is connected in fluid communication with inlet pipe 17 which introduces landfill gasses into system 10. Desiccant filter 30 serves to remove the moisture from the landfill gas. Desiccant filter 30 is preferably a hygroscopic device which operates through absorption or adsorption. Common desiccants which may be utilized within desiccant filter 30 include, but are in no way limited to, drierite, silica gel, calcium sulfate, calcium chloride, montmorillonite clay, and molecular sieves. In alternate forms, desiccant filter 30 may reduce and/or eliminate moisture through another principal, such as chemical bonding of water molecules. In a further form, desiccant filter 30 is removably mounted within system 10 such that it may be replaced upon depletion of its useful life. For example, desiccant filter 30 may be connected to inlet pipe 17 through a threaded connection or the like. One preferred desiccant filter for use is the Mini inline desiccant air dry filter, #ATD-7820, which is available from ATD Tools of Wentzville, Mo.

Connected inline downstream from inlet pipe 17 and desiccant filter 30 is flow meter 40. Flow meter 40 is connected in sealed fluid communication with desiccant filter 30 via intermediate pipe 18. In one form, flow meter 40 is a roto meter, which is a device used to visually indicate and/or adjust flow in which a float rises in a tapered vertical tube to a height dependent on the rate of flow through the tube. Since the flow of landfill gas into system 10 through inlet valve 17 may not be consistent, flow meter 40 provides a mechanism to indicate the current flow at the time of any measurement recorded. In alternate forms, flow meter 30 may be any other type of flow meter providing a visual indication, whether physical, mechanical, electronic, or otherwise, of the measured gas flow. One preferred roto meter for use as flow meter 40 is the Dwyer Series MM flowmeter, which is available from Dwyer Instruments of Michigan City, Ind. In a further form, flow meter 40 may be an active flow regulating device which serves to limit the flow of landfill gas further into system 10 to a desired flow rate. Furthermore, if an active flow regulating device is used, the flow meter 40 may report its flow rate readings to contact terminals 60 which provide for transmission and/or storage of the reported values as further described herein. Additionally, system 10 may include or be utilized in conjunction with a pump to provide landfill gas having a minimum pressure to provide accurate sampling.

System 10 includes a methane meter 50 which is housed within a sealed compartment 22 of housing 12. Methane meter 50 is preferably a point gas detector calibrated for methane detection. As illustrated, methane meter 50 is mounted within compartment 22 which is contained within main housing 12. Methane meter 50 is electrically connected to contact terminals 60 which provide for transmission and/or storage of the readings taken by methane meter 50. In one form, contact terminals 60 connect to and interface with a storage device, such as a flash drive or other storage medium, to record the methane level readings on a continuous or periodic basis. In another form, contact terminals 60 communicate the methane level readings by wire, radio frequency, or cell/data connection to a monitoring station. Additionally, each methane level reading may be paired with a corresponding flow reading from flow meter 40. A wired connection to contact terminal 60 may be in the form of one or more standard interfaces, which may be directly connected to system 10 via wire feed 21, which passes through main housing 12. The methane level data may then be monitored and stored in a database for later use in analysis, reporting, or the like.

In the illustrated embodiment, the sensor end 52 of methane meter 50 extends through wall 24 of compartment 22 into a methane sampling compartment 26. Methane sampling chamber 26 is an isolated portion of housing 12 which includes vents 20 to provide for the eventual dissipation of landfill gasses. The landfill gasses are introduced into the sampling chamber 26 via sample pipe 19. As such, the landfill gasses fill the sampling chamber 26 to enable a proper reading of the sample. One preferred methane meter for use in system 10 is the Searchpoint Optima Plus, which is available from Honeywell International, Inc. of Morristown, N.J.

In a certain preferred forms, compartment 22 is permanently sealed and inaccessible to users after the manufacture of system 10. Additionally, the remaining portion of compartment 22 is preferably filled with anti-static and/or tamper-proof filler (not shown) to physically protect the methane meter 50.

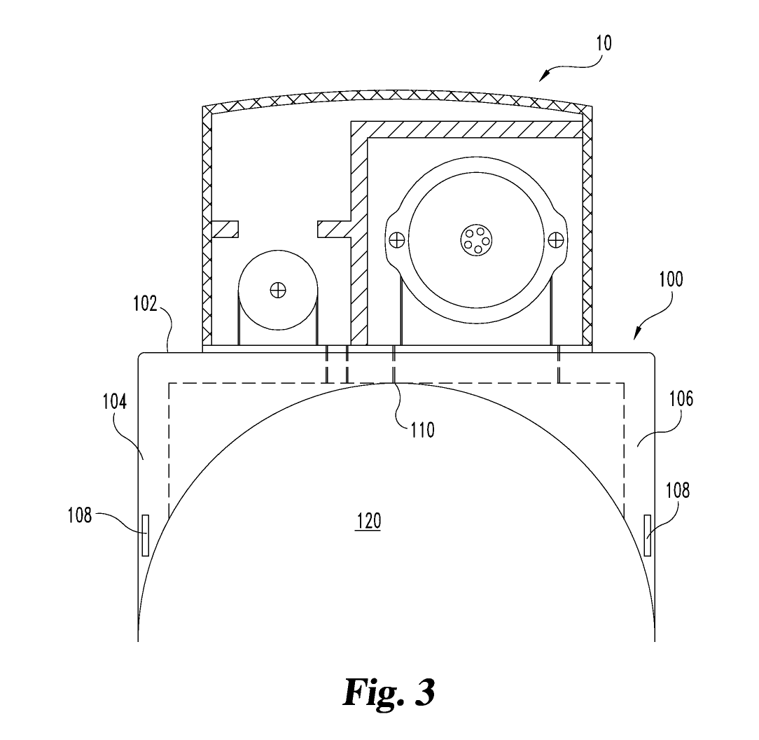

Turning to FIG. 3, one form of a preferred embodiment is illustrated. In this form, system 10 is mounted to a bracket 100 suitable for attachment to a collector pipe 120 of a landfill piping system. The bracket 100 includes a top surface 102 which is flat and has appropriate securement mechanisms to allow system 10 to be securely fastened thereto. Top surface 102 also provides a recess such that a connection between inlet pipe 17 and an appropriate tap in pipe 120 may be made. In addition, bracket 100 includes arms 104 and 106 which extend downward from top surface 102 and around the opposing sides of pipe 120. Preferably, the space between the arms 104 and 106 is designed to slightly exceed the diameter of the pipe 120 to provide for a tight connection. Each arm (104 of 106) includes a slot 108 or other securement point which enables bracket 100 to be secured to the pipe 120. Between the arms 104 and 106 of bracket 100, a cylindrical recess 110 is formed having a radius matching the outer radius of the pipe 120. The cylindrical recess 110 may be formed by a number of saddles or the like spread along the length of bracket 100. In an alternate form, one side of system 10 may be modified to have a semicircular recess along at least a portion of its width.

One advantage of the system 10 is that the internal components, such as desiccant filter 30 and flow meter 40 may be easily replaced without replacing the entire system 10. In addition, the sensitive but longer life methane monitor 50 is protected such that it may not be damaged during routine maintenance of the remaining portions of system 10.

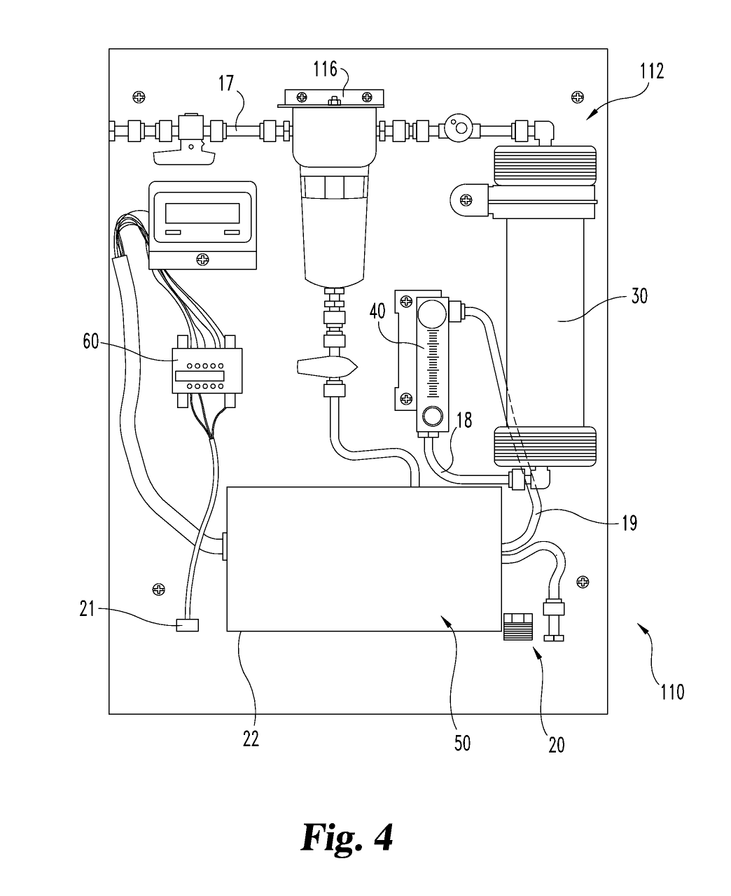

Turning to FIG. 4, a front plan view of a methane monitoring system 110 according to an alternate embodiment of the present invention is shown. System 110 includes a main housing 112 which, according to this embodiment, is in the form of an access panel, preferably a waterproof access panel. In one form, the access panel 112 is an 18″×24″ panel having a swing away door mounted thereto. The remaining components of system 110, shown in FIG. 4, labeled with numbers corresponding with those of FIGS. 1-2 denote common components. For example, system 110 also includes a desiccant filter 30, a flow meter 40, and a methane meter 50, and a contact terminal 60, among others. However, system 110 also includes a particulate filter 116 which serves to reduce particulate and water in the gas prior to its flow into desiccant filter 30.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A device for monitoring methane gas levels within a landfill gas system comprising:
a weatherproof housing having a landfill gas inlet, a sampling chamber having a sampled gas vent leading outside of said housing, and at least a first access panel, wherein said housing contains:
a desccient filter having its inlet in fluid communication with said landfill gas inlet;
a flow restrictor connected between the outlet of said desccient filter and an opening into said sampling chamber; and
a sealed enclosure containing a methane meter, wherein at least a portion of the methane meter extends into said sampling chamber.

2. The device of claim 1, wherein at least a portion of the void between said method meter and the inner surfaces of said sealed enclosure are filled with anti-static filler.

3. The device of claim 2, wherein said anti-static filler provides a visual indicator that the filler has been tampered with.

4. The device of claim 1, wherein said methane meter includes at least one sensor and said sensor is in contact with the gas contained in said sampling chamber.

5. The device of claim 4, wherein said methane meter includes at least two probes and said probes extend into said sampling chamber.

6. The device of claim 5, wherein said methane meter includes an infrared optical sensor.

7. The device of claim 1, further comprising a particulate filter connected between said landfill gas inlet and said desiccant filter.

8. The device of claim 1, wherein said housing is in the form of an electrical panel.

9. The device of claim 1, wherein said device includes at least two arms extending vertically down from at least one side of said device for securing said device mounting of said device to the collector pipe of a landfill gas system.

10. The device of claim 9, wherein said device is configured with said at least one side have a semi-circular concave shape across at least a portion of its width so as to provide for mounting of said device to the collector pipe of a landfill gas system.

11. The device of claim 1, wherein said sealed enclosure includes a first electrical contact terminal accessible from its exterior which is connected to at least one electrical contact of said methane meter.

12. The device of claim 1, wherein said first access panel provides for the removal and replacement of said sealed enclosure from said housing.

13. The device of claim 13, wherein said housing includes a second access panel for providing for the removal and replacement of said desiccant filter from said housing.

14. The device of claim 1, wherein said flow regulator is a roto meter.

15. A device for monitoring methane gas levels within a landfill gas system comprising:
a weatherproof housing having a landfill system gas inlet and at least four separate compartments therein, including:
a first compartment contains a desiccant filter;
a second compartment containing a flow regulator;
a third compartment containing a methane meter; and
a fourth compartment containing at least one probe of said methane meter and a vent outside said housing;
wherein said landfill gas system inlet, said desiccant filter, said flow regulator, and an outlet into said fourth compartment are all connected in series and in fluid communication.

16. The device of claim 15, wherein said third compartment is a sealed enclosure.

17. The device of claim 16, wherein said first and second compartments are sealed.

18. The device of claim 15, wherein said flow regulator is a roto meter.

19. The device of claim 15, wherein said housing includes at least a first access panel for providing for the removal and replacement of said third compartment.

20. A device for monitoring methane gas levels within a landfill gas system comprising:
a weatherproof housing having a landfill gas inlet, a sampling chamber having a sampled gas vent leading outside of said housing, and a first and second access panel, wherein said housing contains:
a replaceable particulate filter having its inlet connected to said landfill gas inlet;
a replaceable desiccant filter having its inlet connected to the outlet of said particulate filter;
a flow restrictor connected between the outlet of said desccient filter and an opening into said sampling chamber; and
a replaceable sealed enclosure containing a methane meter, wherein at least a portion of the methane meter extends into said sampling chamber,
wherein said first access panel provides access to said replaceable desiccant filter and said second access panel provides access to said replaceable sealed enclosure.
